(19) United States
(12) Patent Application Publication
(10) Pub. No.: US 2020/0290698 A1
(43) Pub. Date: Sep. 17, 2020

(54) CHILD OFF-ROAD VEHICLE

(71) Applicant: James Blackwood, Moncks Corner, SC (US)

(72) Inventor: James Blackwood, Moncks Corner, SC (US)

(21) Appl. No.: 16/354,148

(22) Filed: Mar. 14, 2019

(51) Int. Cl. B62K 9/02

(52) U.S. Cl. CPC B62K 9/02; B60Y 2200/132

(57) ABSTRACT

A child vehicle is presented. The child vehicle is an off-road vehicle with one wheel in the back and two wheels on the front. The back wheel is preferably a dirt bike wheel. The front wheels are preferably ATV like wheels. The triangular design allows for a safe, fun environment for a child to learn to, and to continue to ride off-road vehicles.

### FIELD OF THE INVENTION

This invention relates to apparatus for vehicles. More particularly, it relates to off-road vehicles for children.

### BACKGROUND

Ride-on vehicles for children have become increasingly popular due in part to the desire of children to drive self-propelled vehicles resembling full-size vehicles. Such ride-on vehicles, or ride-ons, are typically propelled by battery-powered motors and generally include scaled-down features of full-size vehicles.

One challenge in designing reduced-scale vehicles is to make the vehicle resemble a full-size vehicle, while still providing a vehicle that is safe for use by children. When a ride-on is designed to resemble a four-wheeled vehicle, such as a car or truck, the corresponding ride-on tends to also have four wheels. When a ride-on is designed to resemble a motorcycle, however, a balance must be reached between safety and the accuracy of the reproduction.

Certainly, the most accurate reproduction is for the ride-on to only have two wheels. However, children may not have the size, strength or coordination to balance a two-wheeled ride-on, especially when propelled by the ride-on's motor. Adding additional wheels to the ride-on detracts from the accuracy of the reproduction, and thus may reduce the child's desire for the ride-on.

### BRIEF DESCRIPTION OF THE DRAWINGS

FIG. 1 a frontal view of the exemplary vehicle.

FIG. 2 is side view of the exemplary vehicle.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

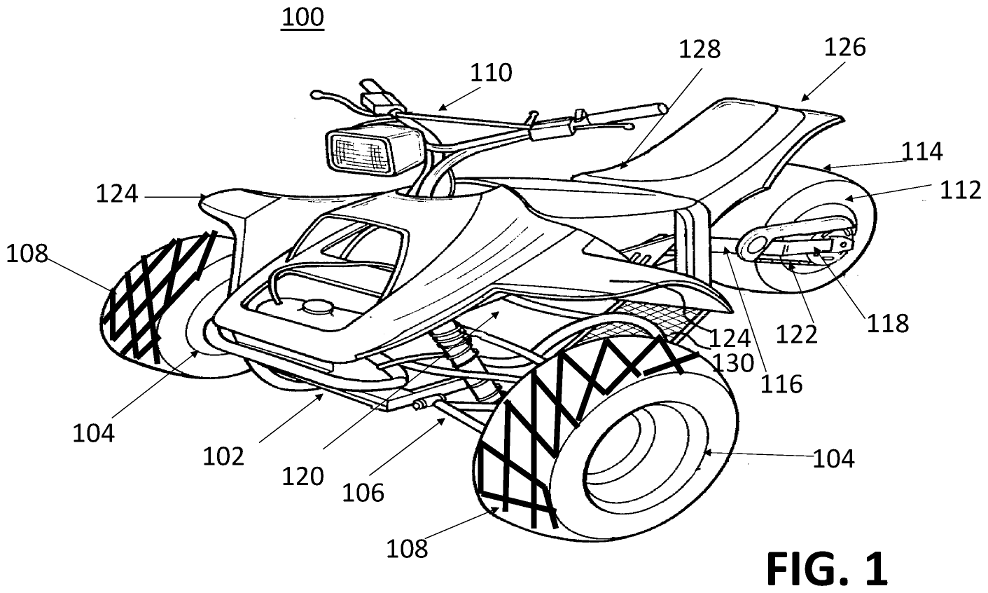

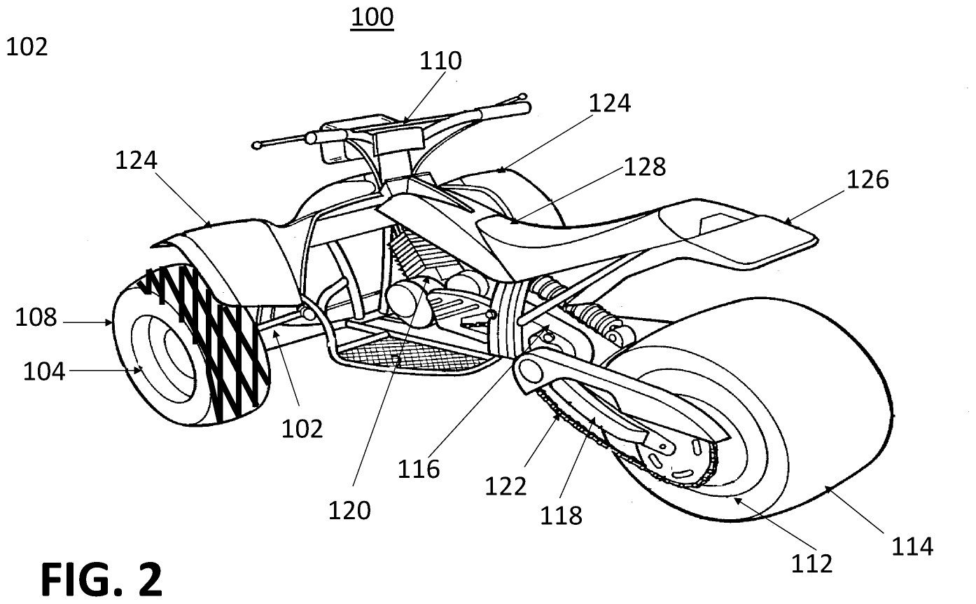

Referring to FIG. 1 and FIG. 2, a child off-road vehicle 100 is presented. The vehicle 100 includes a frame assembly 102 and which may have any specific configuration. However, in a preferred embodiment, the frame 102 is steel and is welded, but could be aluminum or any other material that is appropriate for off-road vehicles. Further, the frame 102 is welded but other techniques may be utilized to make the vehicle strong and safe.

The vehicle 100 has two front wheels 104 are supported at the front end of the frame 102 by means of a front suspension system 106 which may be comprised of the parallel A arm type with the inboard pivot points for the arms being located substantially close to the longitudinal center line of the frame 110 and vehicle 100. The front wheels 104 mount all-terrain vehicle (ATV) tires 108. The term “ATV tires” is intended to encompass those types of tires that are normally mounted on ATVs such as a Kendra K99 Bear Claw ATV tire, a Sedona Extreme Mud All Terrain Tire, etc.

The front wheels 104 and tires 106 are also supported by the suspension system 106 for steering movement about respective steering axes. The steering of the front wheels 104 and tires 108 is accomplished by means of a handlebar mechanism 110 that is mounted on the frame assembly 102 for steering movement and which is coupled to the front wheels 104 in a suitable manner.

The vehicle 100 also includes a rear wheel 112 that mounts a single mud grip tire 1114. It will be seen from the figures that the rear wheel 112 and specifically its mounted tire 114 has a substantially greater width than the width of the front wheels 104 and their mounted tires 108. The contact area between the tires on the front wheels and the ground equals the contact area between the rear wheel tire and the ground give a superior handling experience.

The rear wheel 112 and mounted tire 114 are supported for suspension movement relative to the frame 102 by a trailing arm assembly 116. The trailing arm assembly 116 has a pair of arm portions 118 that extend on the opposite sides of the rear wheel 112 and its mounted tire 114. The suspension movement about this pivot axis is damped and controlled by means of a combined tubular shock absorber and surrounding coil spring assembly.

A power plant 120 is supported within the frame 102 for driving the rear wheel 112 and tire 114. The power plant 120 may be a four-cylinder, gas powered engine that is chain driven.

An output shaft drives a first chain 122 that is disposed substantially close to the longitudinal center line of the frame 102. Alternatively, a shaft drive may be employed. The chain 122 or shaft drive, if it is employed, is utilized to drive one end of an intermediate shaft that is rotatably journaled on the trailing arm 118 in a suitable manner.

A body of a suitable configuration and comprised of a pair of front fenders 124 and a rear fender 126 which overlie the front tires 104 and rear tires 114, respectively, is carried on the frame 102 in an appropriate manner. This body includes a single saddle type seat 128 that is positioned to accommodate a single rider. A pair of foot rests 130 are carried on the frame 102 on opposite sides of its center line and on opposite sides of the power unit 120 for accommodating the feet of the rider on the seat 128.

The placement of the seat 128 and foot rests 130 is such that the rider may center his weight between the front and rear wheels 102 and 112 and specifically between the contact patches of their respective tires 14 and 114. Also, the configuration is such that the rider may conveniently shift his weight forward or rearwardly to assist in maneuvering the vehicle 11.

It should also be noted that even though the rear wheel 112 and rear tire 114 are quite wide, the width is not such that a rider may not place his feet on the ground and permit the vehicle 100 to ride out under him under emergency conditions with the rear wheel and tire 114 passing between the rider's legs.

Also, it should be noted that because a single rear wheel is employed, there will not be the effect of rear wheel steering as would result if there were a pair of driven rear wheels with no differential when traveling over rough terrain when one rear wheel might leave contact with the ground.

Also, the relative contact patches between the front and rear wheels and the rider placement on the frame 102 is such that it is unlikely that the front wheels 104 and specifically their tires 104 will leave contact with the ground when sudden applications of power are made by the rider.

Also, the width of the rear tire 112 should not be too great so as to make steering or turning difficult and the aforementioned relationship is particularly useful in such an arrangement. If these dimensions are equal, there is a very good balance between the front and rear end and even though there are only three wheels, the vehicle is extremely stable and offers very good maneuverability.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A child vehicle, the child vehicle comprising:
a frame;
the frame having a front end, a back end;
a pair of front wheels coupled to the front end of the frame;
a single rear wheel coupled to the rear end of the frame;
a suspension for suspending each of said wheels for independent movement about respective pivot area fixed relative to the frame, and a single seat coupled to the frame midway between the front and rear wheels on a longitudinal center-plane passing through the frame;
an power plant for propelling the back wheel;
the front wheels and rear wheels having tires; and
a wheel base between the front wheels and the rear wheel being equal to the tread between the front wheels.

2. The child vehicle of claim 1, wherein the seat being a saddle type seat.

3. The child vehicle of claim 1, further comprising foot support coupled to the frame, the rear wheel having a width that is sized so as to pass between the legs of a rider if the rider stands on the ground to permit the vehicle to ride out from underneath the rider.

4. The child vehicle of claim 1, wherein the back wheel being a single mud grip.

5. The child vehicle of claim 1, wherein the front wheels being a 10-ply radial tire.

6. The child vehicle of claim 1, wherein the is a four-stroke engine.

7. The child vehicle of claim 6, wherein the four-stroke engine being a pull start.

8. The child vehicle of claim 1, wherein the engine being gas powered.

9. The child vehicle of claim 1, wherein the engine propels the back wheel by a chain.

10. The child vehicle of claim 1, wherein the frame being steel.

11. The child vehicle of claim 1, wherein the tires of the front wheels being rheumatic tires.

12. The child vehicle of claim 1, wherein the suspension being heavy duty shock absorbers.
